(19) United States
(12) Patent Application Publication
(10) Pub. No.: US 2007/0266418 A1
(43) Pub. Date: Nov. 15, 2007

(54) Multimedia display apparatus with add-on personal computer functions capable of entering keyboard keys with remote control

(75) Inventor: Yet-Zen Lin, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/497,320

(22) Filed: Aug. 2, 2006

(30) Foreign Application Priority Data
May 15, 2006 (TW) 095117114

(51) Int. Cl. H04N 7/16; H04N 7/173; H04N 5/445; G06F 3/00

(52) U.S. Cl. 725/133; 725/141; 725/153; 725/37

(57) ABSTRACT

A multimedia display apparatus with add-on personal computer functions capable of entering keyboard keys with a remote control, including a display and a remote control. Display is built-in a PC unit operable in a TV mode and a PC mode. The display outputs video in the TV mode and displays computational data processed by the PC unit in the PC mode. When the display operates in the PC mode and the PC unit requires input, the keyboard function key is pressed to display a keyboard window as an OSD at a predetermined position of the display. The set of arrow keys are used to select symbols displayed on the keyboard window to be entered to the PC unit.

### BACKGROUND OF THE INVENTION

1. Field of the Invention

The present invention relates to a multimedia display apparatus. More particularly, the present invention relates to a multimedia display apparatus with add-on personal computer functions capable of entering keyboard keys with a remote control.

2. Description of Related Art

Traditionally, big-screen multimedia displays, especially for sizes of 30″ and above, used as TVs or monitors are generally desktop types, which can be connected with a PC (Personal Computer) to perform data computation, word processing, web browsing, and email sending/receiving. Due to the nature of large screen sizes, user needs to stay a good distance (above 1.5 meters) from the display monitor for optimal eye-view. When PCs are connected to these big-screen multimedia displays, the complicated wiring, i.e. cables for the display, VGA, audio, keyboard, mouse, and power, that cover the whole length of the floor between the PC and the display, gives the environment a untidy and disorderly look. Thus, multimedia displays that embed the functions of a PC with TV viewing have been introduced to thereby remove the need for cumbersome wires. Such multimedia display typically requires a user to watch TV using a remote control to browse through channels, and perform PC tasks using a mouse and a keyboard for navigation and character input.

The disclosure of such embedded multimedia display can be found in U.S. Pat. No. 6,757,707 granted to Houghton et al for a web-based TV system, which uses the combination of a wireless keyboard and a remote control for entering non-numeric characters and executing commands respectively. However, the requirement of two separate sets of input devices for TV and PC operation is greatly inconvenient.

Therefore, a more intuitive approach is use of a single remote control to operate the multimedia display for both watching TV and functioning as a PC, such as for surfing the Internet, which requires less complicated key inputs. However, when a user wishes to enter keyword searches while browsing the Internet, such as for train schedule look-up, the lack of non-numeric character keys on a remote control proves that the multimedia display is short from becoming a convenient and user-friendly system.

Therefore there is a need to improve the aforementioned problems associated with current multimedia displays when non-numeric character inputs are needed.

### SUMMARY OF THE INVENTION

The object of the present invention is to provide a multimedia display apparatus with add-on personal computer functions capable of entering keyboard keys with a remote control, for incorporating personal computer into the multimedia display apparatus so as to increase the add-on value of the multimedia display apparatus.

To achieve the object, the multimedia display apparatus of the present invention includes a display and a remote control. The display has built-in a PC (Personal Computer) unit, operable in a TV mode and a PC mode. In the TV mode, the display outputs video; in the PC mode, the display displays computational data processed by the PC unit. The remote control includes a keyboard function key, and a set of arrow keys, and is for remote controlling the display. When the display operates in the PC mode and the PC unit requires input, the keyboard function key is pressed to display a keyboard window as an OSD (On-Screen Display) on the display. The set of arrow keys are then used to select symbols displayed on the keyboard window to be entered to the PC unit.

The symbols displayed on the keyboard window include English alphabets, and can also include Chinese Zhuyin alphabets, Chinese Canjie radicals, or Japanese kana characters.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram illustrating an exemplary screenshot of a display according to a preferred embodiment of the invention;

FIG. 2 is a schematic diagram illustrating system architecture of a multimedia apparatus according to a preferred embodiment of the invention;

FIG. 3 is a schematic diagram illustrating a remote control according to a preferred embodiment of the invention; and

FIG. 4 is a chart illustrating functions of operation of a remote control according to a preferred embodiment of the invention.

### DETAILED DESCRIPTION OF THE PREFERRED EMBODIMENT

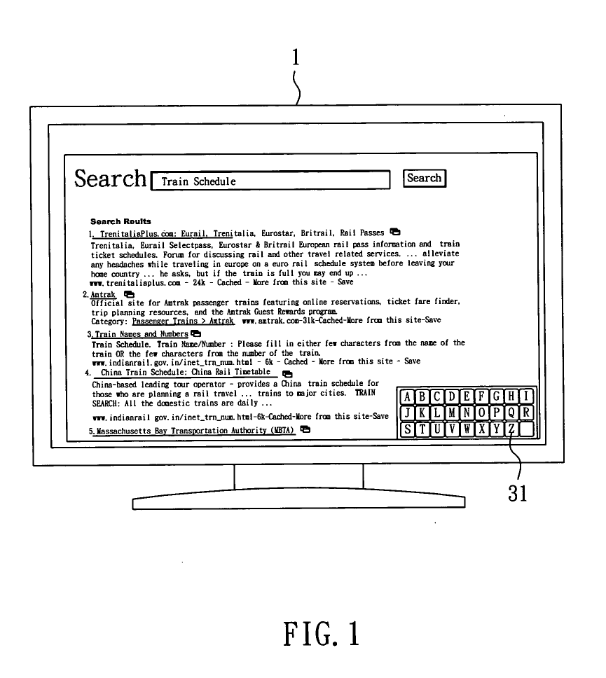

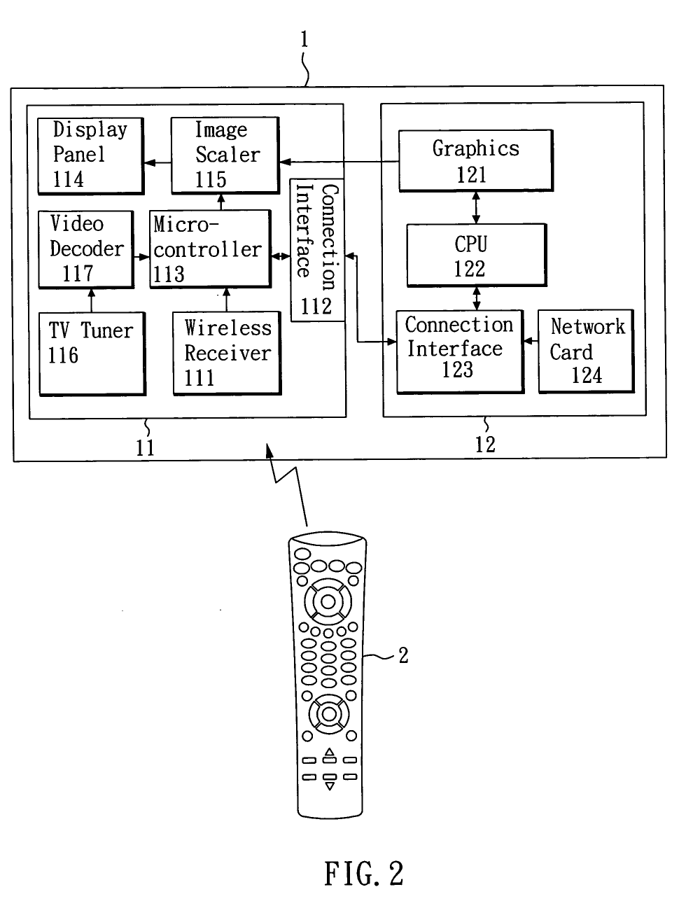

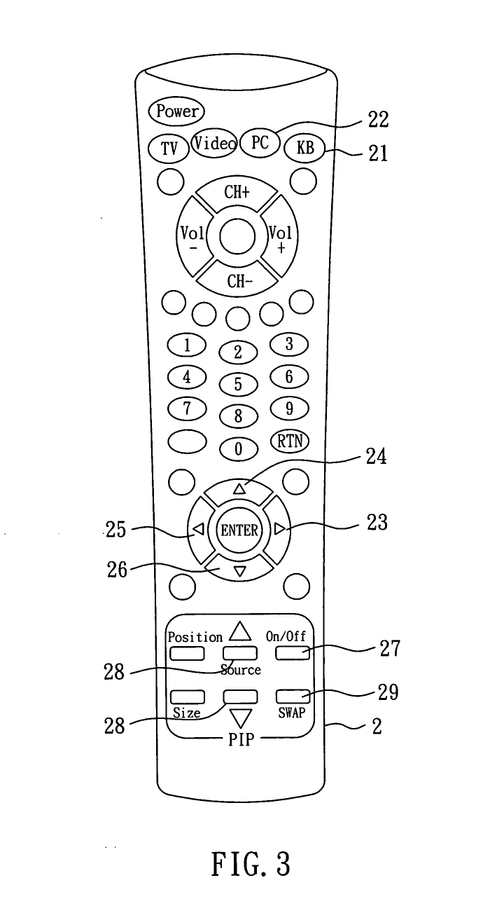

The present invention discloses a multimedia display apparatus with add-on personal computer functions capable of entering keyboard keys with a remote control. FIG. 1 shows a preferred embodiment of the invention. FIG. 2 shows illustration of the system architecture of the preferred embodiment of the invention. FIG. 3 shows illustration of a remote control according to a preferred embodiment of the invention. The multimedia display apparatus of the invention includes a display 1 and a remote control 2.

As shown in FIG. 1 and FIG. 2, display 1 has a built-in display unit 11 and a PC unit 12, and can selectively operate in a TV mode and a PC mode. When operating under the TV mode, display 1 outputs video through display unit 11. When operating under the PC mode, the PC unit 12 executes data computation, and the result of which is displayed by display unit 11. Display unit 11 includes a wireless receiver 111, a connection interface 112, a microcontroller 113, an image scaler 115, and a display panel 114. Wireless receiver 111 is for receiving commands from remote control 2. Display unit 11 is electrically connected to PC unit 12 via connection interface 112. Microcontroller 113 is electrically connected to wireless receiver 111, and connection interface 112. Display panel 114 is for displaying pictures. Image scaler 115 is for scaling the pictures, and also provides OSD (On-Screen Display) function. Display unit 11 can also include a tuner 116 and a video decoder 117, allowing the user to choose among different channels under the TV mode.

PC unit 12 includes a graphics card 121, a CPU (Central Processing Unit) 122, a network card 124, and a connection interface 123. Graphics card 121 is used to perform image processing. CPU 122 is for logic computation. Network card 124 enables connection to the Internet. Connection interface 123 is electrically connected to connection interface 112 of display unit 11. In this embodiment, connection interface 112 is an IIC (Inter-Integrated Circuit) control bus. In other embodiments, connection interface 112 can also be a RS-232 bus interface.

Remote control 2 is for remote controlling display 1. As shown in FIG. 3, remote control 2 includes a keyboard function key 21, a PC function key 22, a right arrow key 23, an up arrow key 24, a left arrow key 25, and a down arrow key 26. When the PC function key 22 is pressed, the display is triggered to operate in the PC mode.

Referring both to FIG. 1, and FIG. 3, during a scenario when display 1 is operating in the PC mode, and PC unit 12 requires input, such as when a user desires to lookup train schedule on the Internet and wishes to key-in train number to refine a search, then the keyboard function key 21 on remote control 2 is pressed to call the keyboard window 31 to be displayed as an OSD at a predetermined position (e.g. bottom-right corner) of the display 1. Through the arrow keys on remote control 2, namely, right arrow key 23, up arrow key 24, left arrow key 25, and down arrow key 26, user can then choose among the symbols displayed in the keyboard window 31 to enter into PC unit 12. Preferably, the symbols displayed on the keyboard window are English alphabets, and can also be Chinese Zhuyin alphabets, Chinese Canjie radicals, or Japanese kana characters.

Through such arrangements, the multimedia display apparatus with add-on personal computer functions capable of entering keyboard keys with a remote control provided by the invention is able to incorporate the functionality of a personal computer into the multimedia display apparatus to effectively increase value of the multimedia display apparatus.

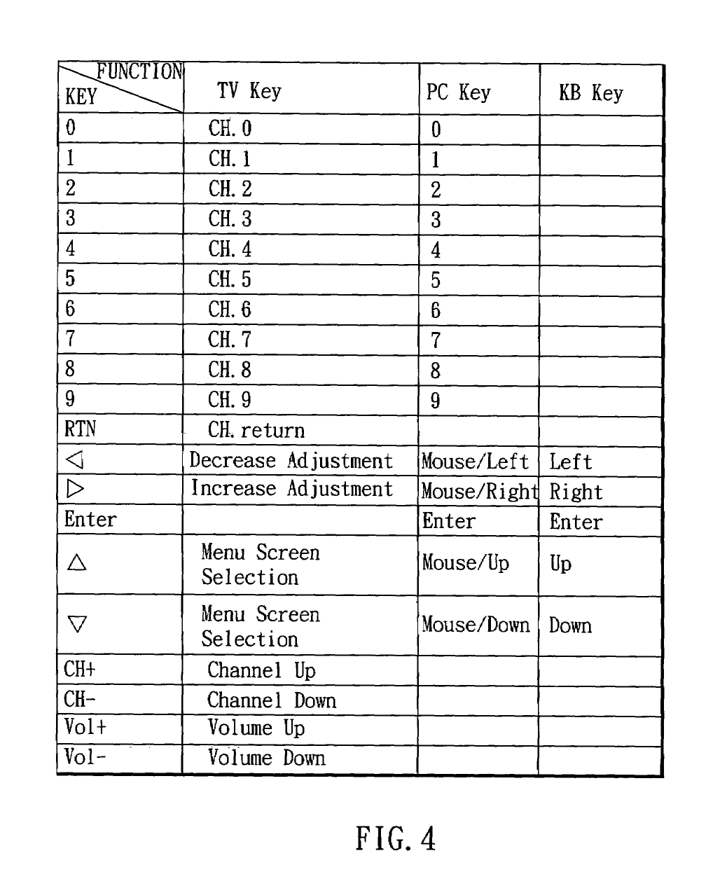

FIG. 4 shows a chart illustrating the functions of a remote control according to a preferred embodiment of the invention. Referring to FIGS. 1, 3, and 4, a user can enter the PC mode by simply pressing the PC function key 22 on remote control 2, which can then be used as a mouse to navigate a mouse cursor in orthogonal coordinate directions by pressing the corresponding right arrow key 23, up arrow key 24, left arrow key 25, or down arrow key 26. That is, when an arrow key is pressed, the remote control 2 emits a corresponding signal that propagates through air and is received by wireless receiver 111, which passes the signal through connection interfaces 112 and 123 to PC unit 12. Based upon the signal received, PC unit 12 then controls the mouse cursor to move in a corresponding direction towards right, up, left, or down. For instance, the mouse cursor can be made to move towards top-right of display 1 by first pressing right arrow key 23, followed by up arrow key 24. Also, if user decides to key-in characters other than numbers, such as for performing a train schedule look-up on Internet, he/she can first press the keyboard function key 21 to display keyboard window 31 as an OSD at the bottom-right of display 1. Through the right arrow key 23, up arrow key 24, left arrow key 25, and down arrow key 26 on remote control 2, user can then choose among the symbols displayed in the keyboard window 31 to be entered into PC unit 12. In this embodiment, the keyboard function key 21 of remote control 2 is only functional when display 1 operates under PC mode.

Preferably, the sub picture 30 is adjustable in position and size. When display 1 operates under PC mode, user can first press PIP toggle key 29 to enter the configuration screen of sub picture 30, and then press sub picture signal source key 28, for instance, to re-position the sub picture 30 to the upper or lower corner, or decrease the width of sub picture 30.

Although the present invention has been explained in relation to its preferred embodiment, it is to be understood that many other possible modifications and variations can be made without departing from the scope of the invention as hereinafter claimed.

What is claimed is:

1. A multimedia display apparatus with add-on personal computer functions capable of entering keyboard keys with a remote control, the multimedia display apparatus comprising:
a display, having built-in a PC (Personal Computer) unit, operable in a TV mode and a PC mode for outputting video in the TV mode, and displaying computational data processed by the PC unit in the PC mode; and
a remote control, having a keyboard function key, and a set of arrow keys, for remote controlling the display;
wherein, when the display operates in the PC mode and the PC unit requires input, the keyboard function key is pressed to display a keyboard window as an OSD (On-Screen Display) at a predetermined position of the display, and the set of arrow keys are used to select and enter symbols displayed on the keyboard window to the PC unit.

2. The multimedia display apparatus as claimed in claim 1, wherein the display includes a wireless receiver for receiving commands from the remote control.

3. The multimedia display apparatus as claimed in claim 1, wherein the display is electrically connected to the PC unit via a connection interface.

4. The multimedia display apparatus as claimed in claim 3, wherein the connection interface includes an IIC (Inter-Integrated Circuit) control bus.

5. The multimedia display apparatus as claimed in claim 3, wherein the connection interface includes a RS-232 control bus.

6. The multimedia display apparatus as claimed in claim 1, wherein the remote control further includes a PC function key, for controlling the display to operate in the PC mode when pressed.

7. The multimedia display apparatus as claimed in claim 6, wherein the set of arrow keys includes a right arrow key, a up arrow key, a left arrow key, and a down arrow key that upon pressing causes the respective right, up, left, and down movements of a mouse cursor.

8. The multimedia display apparatus as claimed in claim 1, wherein the symbols displayed on the keyboard window include English alphabets.

9. The multimedia display apparatus as claimed in claim 1, wherein the symbols displayed on the keyboard window include Chinese Zhuyin alphabets.

10. The multimedia display apparatus as claimed in claim 1, wherein the symbols displayed on the keyboard window include Chinese Canjie radicals.

11. The multimedia display apparatus as claimed in claim 1, wherein the symbols displayed on the keyboard window include Japanese kana characters.

12. The multimedia display apparatus as claimed in claim 1, wherein the keyboard window is displayed as an OSD at a bottom-right corner of the display.
